(19) United States
(12) Patent Application Publication
(10) Pub. No.: US 2007/0281129 A1
(43) Pub. Date: Dec. 6, 2007

(54) DIFFUSER FILMS AND METHODS FOR MAKING AND USING THE SAME

(76) Inventors: Chi Kwong Chan, Kowloon (HK); Yaowen Bai, Beijing (CN); Jinghui Xu, Shenzhen (CN); Adel Bastawros, Newburgh, IN (US); Karkala Arun Kumar, Evansville, IN (US)

Correspondence Address: CANTOR COLBURN, LLP, 55 GRIFFIN ROAD SOUTH, BLOOMFIELD, CT, 06002, US

(21) Appl. No.: 11/422,390

(22) Filed: Jun. 6, 2006

(51) Int. Cl. B29C 47/14; B29C 59/04; G11B 5/64

(52) U.S. Cl. 428/141; 264/210.2

(57) ABSTRACT

In one embodiment, the diffuser film comprises a polymer composition, a first surface, and a second surface opposite the first surface. The diffuser film is capable of diffusing light. The diffuser film, without a coating, has a film haze of about 10% to about 80%, and has no visible mura defects under panel observation as determined with a backlight display having a center brightness of about 6,000 nit to about 6,300 nit.

### BACKGROUND

This application relates to optical sheet material and, more specifically, to such sheet material characterized by light diffusion properties.

In backlight computer displays or other display systems, optical films or sheet materials are commonly used to direct, diffuse or polarize light. For example, in backlight displays, advanced display films use prismatic structures on the surfaces thereof to direct light along a viewing axis (i.e., an axis normal to the display). This enhances the brightness of the light viewed by the user of the display and allows the system to consume less power in creating a desired level of on-axis illumination. Such films can also be used in a wide range of other optical designs, such as in projection displays, traffic signals, and illuminated signs.

In current displays systems, for example in liquid crystal displays (LCD), it is desirable to have diffusing components. Examples of the utility of diffusing components include (but are not limited to) masking artifacts, such as seeing electronic components located behind the diffuser film, improved uniformity in illumination and increased viewing angle. In a typical LCD display, diffusion of light is introduced into the backlight assembly by adding separate films (i.e., a stack) that are comprised of a non-diffusing substrate to which a highly irregular, diffusing surface treatment is applied or attached. It is thus desirable to generate diffuse light without the added cost of separate films.

Currently, monolithic diffusers have a strong visual defect know as the “mura defect”. These defects appear as low contrast, non-uniform brightness regions. When this diffuser is applied in a backlight unit (BLU), there is some shiny, glaze spot appearance when the BLU is viewed in some view angles. These defects are not commercially acceptable. Hence, there is a continuing need for monolithic film diffusers having reduced mura defects.

### SUMMARY

Disclosed herein are diffuser films and methods for making and using the same.

In one embodiment, the diffuser film comprises a polymer composition, a first surface, and a second surface opposite the first surface. The diffuser film is capable of diffusing light. The diffuser film, without a coating has a film haze of about 10% to about 80%, and has no visible mura defects under panel observation as determined with a backlight display having a center brightness of about 6,000 nit to about 6,300 nit.

In another embodiment, the diffuser film comprises a polymer composition, a first surface, and a second surface opposite the first surface. The diffuser film is capable of diffusing light. The diffuser film, without a coating, has fewer visible mura defects under panel observation as determined with a backlight display having a center brightness of about 6,000 nit to about 6,300 nit, than a second diffuser film comprising the polymer composition, and having the same thickness and haze, and having a surface with an average second diffuser surface Ra of greater than 1.3.

In one embodiment, a method for making the diffuser film comprises: heating a polymer to greater than or equal to a glass transition temperature of the polymer to form a polymer melt, and producing the diffuser film with a surface texture on each side of the diffuser film. The diffuser film is capable of diffusing light. The diffuser film, without a coating, has no visible mura defects under panel observation as determined with a backlight display having a center brightness of about 6,000 nit to about 6,300 nit.

The above described and other features will be appreciated and understood from the following detailed description, drawings, and appended claims.

### BRIEF DESCRIPTION OF THE DRAWINGS

Refer now to the figures, which are exemplary embodiments, and wherein the like elements are numbered alike.

FIG. 1 is a perspective view of a backlight display device including a light diffuser film.

FIG. 2 is a perspective view of a backlight display device including a stack of optical substrates including multiple light diffuser films.

FIG. 3 is a schematic view of a continuous extrusion system illustrating the extrusion of a thermoplastic melt downward into the nip between two calendaring rolls.

FIG. 4 is a schematic front view of a back-light display with the luminance points illustrated.

### DETAILED DESCRIPTION

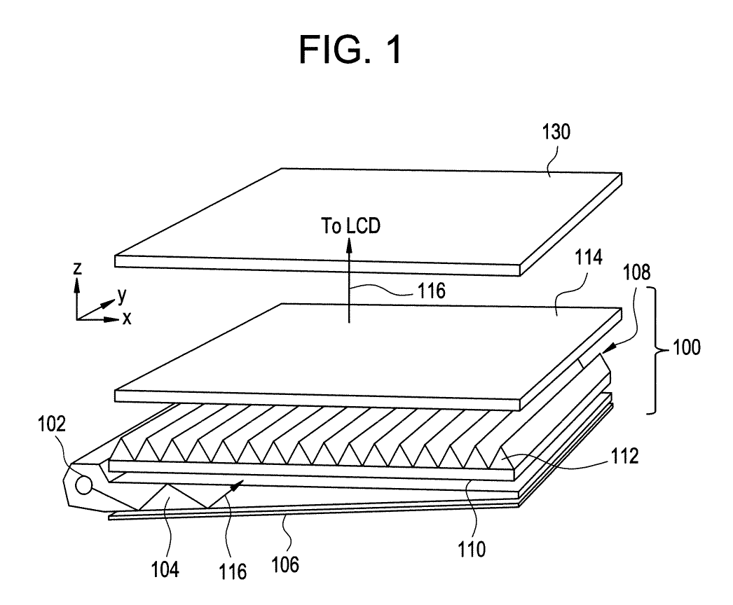

FIG. 1 illustrates a perspective view of a backlight display device 100 comprising an optical source 102 for generating light 116. A light guide 104 guides the light 116 therealong by total internal reflection. A reflective device 106 positioned along the light guide 104 reflects the light 116 out of the light guide 104. A light collimating optical substrate 108 positioned above the light guide 104 is receptive of the light 116 from the light guide 104. The collimating film 108 comprises, on one side thereof, a planar surface 110 and on a second, opposing side thereof, a prismatic surface 112. The collimating film 108 is receptive of the light 116 and acts to direct the light 116 in a direction that is substantially normal to the collimating film 108 along a direction z as shown. The light 116 is then directed to a diffuser film114 located above the collimating film 108 to provide diffusion of the light 116. The diffuser film 114 is receptive of the light 116 from the collimating film 108. The light 116 proceeds from the diffuser film 114 to a liquid crystal display (LCD) 130.

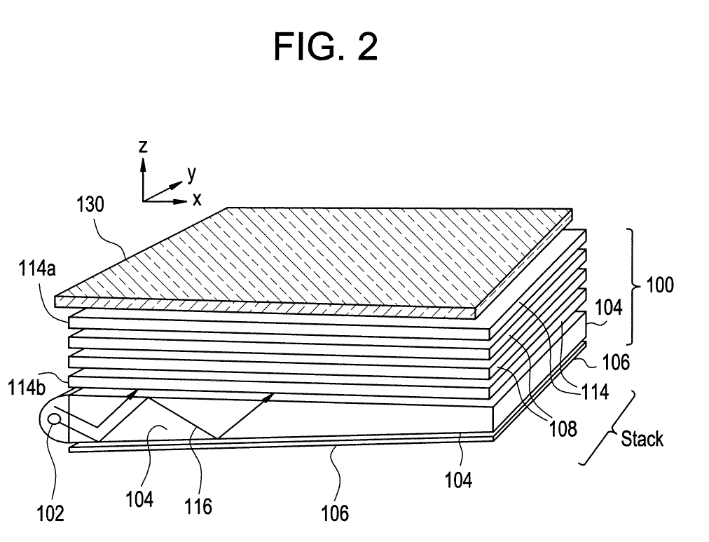

As illustrated in FIG. 2, the backlight display device 100 may include a plurality of optical substrates 108, 114 arranged in a stack as shown. Furthermore, the prismatic surfaces 112 of the substrates 108 may be oriented such that the direction of the features of the prismatic surfaces 112 are positioned at an angle with respect to one another, e.g., 90 degrees (and/or such that the prismatic surfaces are on the same side of the optical substrate as the light guide 104). Still further, it will be appreciated that the prismatic surfaces 112 may have a peak angle, α, a height, h, a pitch, p, and a length, l. These parameters of peak angle, α, a height, h, a pitch, p, and a length, l, may have prescribed values or may have values which are randomized or at least pseudo-randomized. Films with prismatic surfaces with randomized or pseudo-randomized parameters are described for example in U.S. Pat. No. 6,862,141 to Olcazk.

It is noted that in various embodiments a backlight display device can comprise a plurality of brightness enhancement films and a plurality of light-diffuser films in optical communication with each other. The plurality of brightness enhancement films and light-diffuser films can be arranged in any configuration to obtain the desired results in the LCD. Additionally, as briefly mentioned above, the arrangement, type, and amount of brightness enhancement film(s) and light-diffuser film(s) depends on the backlight display device in which they are employed. An increasingly common use of a backlight display device is in a laptop computer.

Computer notebook configurations, for example, can utilize a light source 102 (such as a cold cathode florescent light (CCFL)), an adjacent reflector 106, and a light guide 104. The configuration includes a bottom diffuser 114b adjacent the light guide 104, a top diffuser film 114a, with the collimating films 108 are located between the top and bottom diffuser films 114a, 114b.

The materials of the diffuser film can comprise a variety of transparent and/or semi-transparent resins. Some exemplary materials include polycarbonate (PC), polystyrene (PS), polyethylene terephthalate (PET), polymethyl methacrylate (PMMA), and so forth, as well as combinations comprising at least one of the foregoing.

The diffusion films can, independently, include an anti-static material such as a material comprising a fluorinated phosphonium sulfonate in an amount sufficient to impart anti-static properties to the film. Exemplary anti-static materials are described in U.S. Pat. No. 6,194,497 to Henricus et al. In one embodiment, the phosphonium sulfonate is a fluorinated phosphonium sulfonate and comprising a fluorocarbon containing an organic sulfonate anion and an organic phosphonium cation. Examples of such organic sulfonate anions include: perfluoro methane sulfonate, perfluoro butane sulfonate, perfluoro hexane sulfonate, perfluoro heptane sulfonate, and perfluoro octane sulfonate. Examples of phosphonium cations include: aliphatic phosphonium (such as tetramethyl phosphonium, tetraethyl phosphonium, tetrabutyl phosphonium, triethylmethyl phosphonium, tributylmethyl phosphonium, tributylethyl phosphonium, trioctylmethyl phosphonium, trimethylbutyl phosphonium trimethyloctyl phosphonium, trimethyllauryl phosphonium, trimethylstearyl phosphonium, and triethyloctyl phosphonium) and aromatic phosphoniums (such as tetraphenyl phosphonium, triphenylmethyl phosphonium, triphenylbenzyl phosphonium, and tributylbenzyl phosphonium). The fluorinated phosphonium sulfonate can also be a combination comprising at least one of these organic sulfonate anions and/or organic cations.

An exemplary phosphonium sulfonate is a fluorinated phosphonium sulfonate having the general formula: {CF₃(CF₂)ₙ(SO₃)}θ {P(R1)(R2)(R3)(R4)}Φ wherein F is fluorine; n is an integer of from 1-12, S is sulfur; R1, R2 and R3, independently, have an aliphatic hydrocarbon radical of 1-8 carbon atoms or an aromatic hydrocarbon radical of 6-12 carbon atoms; and R4 is a hydrocarbon radical of 1-18 carbon atoms.

The light diffusing properties of the diffuser film 114 can be imparted to the film by imprinting surface texture on the surfaces of the film. In order to reduce and even eliminate visual mura defects, a texture (e.g., random texture or a patterned texture), can be imparted to the film. The film can have, on both surfaces, an average surface roughness (Ra) of less than or equal to about 1 micrometers (μm), or, more specifically, less than or equal to about 0.8 μm, or, even more specifically, less than or equal to about 0.7 μm, and yet more specifically, about 0.2 μm to about 0.6 μm. The Ra is a measure of the average roughness of the film. It can be determined by integrating the absolute value of the difference between the surface height and the average height and dividing by the measurement length for a one dimensional surface profile, or the measurement area for a two dimensional surface profile. More particularly, surface roughness can be measured using a Surfcorder SE1700a, commercially available from Kosaka Laboratory Ltd., wherein the surface roughness is measured according to ASME B46.1-1995. Visual, as used herein, is intended to be with the naked human eye, unless specifically specified otherwise.

This diffuser film can have a haze of greater than or equal to about 10%, or, more specifically, greater than or equal to about 43%, or, even more specifically, about 40% to about 80% as measured in accordance with ASTM D1003-00.

It is noted that the percent haze can be predicted and calculated from the following equation:

$$\% Haze = 100 \times \frac{Total Diffuse Transmission}{Total Transmission} \qquad ( 1 )$$

wherein total transmission is the integrated transmission; and the total diffuse transmission is the light transmission that is scattered by the film as defined by ASTM D1003-00. For example, a commercially available hazemeter can be used, such as the BYK-Gardner Haze-Gard Plus, with the rough diffusing side of the film facing the detector.

The diffuser film can be formed from a variety of technologies including melt calendaring, melt casting, hot press, solvent casting, as well as other processes for forming a textured surface. An embodiment of making a diffuser film comprises feeding thermoplastic resin(s), or, more specifically, transparent and/or semi-transparent resin(s) (e.g., polycarbonate resin) to an extruder; melting the thermoplastic resin(s) by heating to a temperature greater than or equal to its glass transition temperature (Tg); extruding the resulting molten resin through a die into a nip (e.g., the gap between two calendering rolls); and cooling the resulting film to below its glass transition temperature. Due to the surface texture of the calendering rolls, the resultant film has the desired texture and diffusion properties.

The calendaring rolls can, independently, have glass, metal (steel, copper, chrome, nickel, alloys, etc.), rubber (EPDM, silicone rubber, etc.), and/or a polymer surface. Depending upon the type of roll, the textured surface can be produced by blasting grit, laser engraving, electro-discharge texturing onto the surface, by electroplating, and so forth. It is noted that the size of the rollers, material of the rollers, number of rollers, the film wrap around the rollers, and the like can vary with the system employed. Further, it is noted that processing conditions (e.g., the temperature of the calendering rollers, the line speed, nip pressure, and the like) are controlled to produce the desired haze value and luminance in the resultant diffuser film.

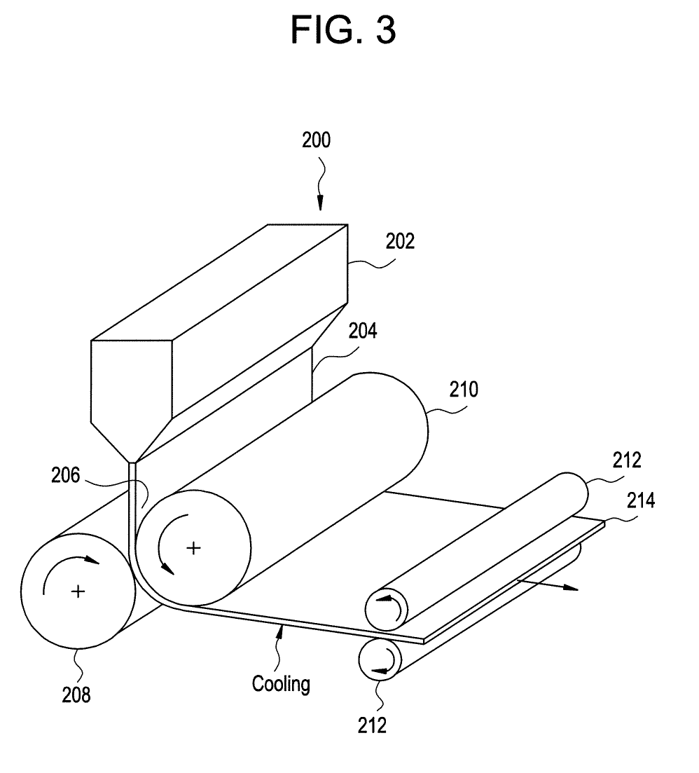

Referring to FIG. 3, in an exemplary extrusion system 200, molten thermoplastic resin 204 is extruded from slot die 202. The molten thermoplastic resin 204 is then passed through a nip 206 formed by calendering rolls 208 and 210, and is cooled (actively and/or passively). The film is, then, pulled out from the nip 206 by the pull rolls 212. The cooled film can be rolled (stored) to be subsequently processed, or can be immediately processed (e.g., cut for use in a backlit display device).

Optical source (e.g., 102 in FIG. 1) can include any light source suitable to backlight a liquid crystal display (LCD) device, which includes both high-brightness and low brightness light sources. The high-brightness light source can include a cold cathode fluorescent lamp (CCFL), a fluorescent lamp, and the like. The low-brightness light source can include a light emitting diode (LED), and the like.

Light guide (e.g., 104) can comprise a material that assumes a low internal absorption of the light, including an acrylic film and desirably transparent materials including acryl, PMMA (polymethylmethacrylate), polycarbonate, polyethylene, selenium (Se), silver chloride (AgCl), and the like. The shape of the light guide can be in a shape suitable for the desired transmission of the light, such as a bar, a curved surface, a plate, a sheet, and the like. The light guide can be a single sheet or a plurality of sheets.

Reflective film (e.g., 106) can be in any usable shape for reflecting light, e.g., a planar shape, such as a plate, sheet, coating and the like, wherein the reflective film comprises a reflective material. For example, suitable reflective materials include an aluminum, a silver, titanium oxide, and the like, as well as combinations comprising at least one of the foregoing. In other embodiments, the reflective film can comprise a thermoplastic material, e.g., Spectralon® (available from Labsphere, Inc.), titanium-oxide pigmented Lexan® (available from General Electric Plastics, Pittsfield, Mass.), and the like.

The collimating film(s) (e.g., 108) comprise light-redirecting structure(s) (e.g., prismatic, (pyramid-like) cube corners, spheres, edges, and the like) to direct light along the viewing axis (i.e., normal to the display), which enhances the luminance (brightness) of the light viewed by the user of the display and allows the system to use less power to create a desired level of on-axis illumination. Generally, the collimating film comprises a base film that can comprise an optional curable coating disposed thereon. The light-redirecting structure can be created, for example, by applying the curable coating to the base film and casting the desired light-redirecting structure in the curable coating, by hot-embossing the structure directly onto the base film, or the like. The disposition of the light-redirecting structure(s) may negate or minimize the original texture on the base film by either matching the refractive indexes of the base film layer and the light-redirecting layer, and/or by melting the textured surface and reforming the first surface to impose light-redirecting properties.

While the base film material can vary depending on the application, suitable materials include those base film materials discussed in published U.S. Patent Application No. 2003/0108710 to Coyle et al. More specifically, the base film material of the collimating film can comprise metal, paper, acrylics, polycarbonates, phenolics, cellulose acetate butyrate, cellulose acetate propionate, poly(ether sulfone), poly(methyl methacrylate), polyurethane, polyester, poly(vinylchloride), polyethylene terephthalate, and the like, as well as blends copolymers, reaction productions, and combinations comprising at least one of the foregoing.

In one embodiment, the base film of the collimating film is formed from a thermoplastic polycarbonate resin, such as Lexan® resin. Thermoplastic polycarbonate resin that can be employed in producing the base film, include without limitation, aromatic polycarbonates, copolymers of an aromatic polycarbonate (such as polyester carbonate copolymer), as well as combinations comprising polycarbonate, depending on the end use application. In another embodiment, the thermoplastic polycarbonate resin is an aromatic homo-polycarbonate resin such as the polycarbonate resins described in U.S. Pat. No. 4,351,920 to Ariga et al. These polycarbonate resins can be obtained by the reaction of an aromatic dihydroxy compound with a carbonyl chloride. Other polycarbonate resins can be obtained by the reaction of an aromatic dihydroxy compound with a carbonate precursor such as a diaryl carbonate. An exemplary aromatic dihydroxy compound is 2,2-bis(4-hydroxy phenyl) propane (i.e., Bisphenol-A). A polyester carbonate copolymer is obtained by the reaction of a dihydroxy phenol, a carbonate precursor and dicarboxylic acid such as terephthalic acid or isophthalic acid or a mixture of terephthalic and isophthalic acid. Optionally, an amount of a glycol can also be used as a reactant.

While it is noted that the thickness of the base film of the collimating film, as well as the diffuser film, can vary depending on the desired application, the base film and diffuser film can, individually, comprise a thickness sufficient for use in a flat panel display, e.g., for use in a laptop computer. For example, the thickness can be about 25 micrometers to about 1,000 micrometers, specifically about 50 micrometers to about 750 micrometers.

In embodiments comprising a curable coating on the base film of the brightness enhancement film, the curable coating comprises a curable composition, which generally comprises a polymerizable compound. Polymerizable compounds, as used herein, are monomers or oligomers comprising one or more functional groups capable of undergoing radical, cationic, anionic, thermal, and/or photochemical polymerization. Suitable functional groups include, for example, acrylate, methacrylate, vinyl, epoxide, and the like.

The following examples are merely exemplary, not limiting.

### EXAMPLES

TABLE 1
Roll Configuration

| Properties | Sample 1 | Sample 2 | Sample 3 | Sample 4 |
|---|---|---|---|---|
| | Roll 210 | | | |
| Surface Materials | Steel | Steel | Steel | Steel |
| Diameter | 500 mm | 500 mm | 500 mm | 500 mm |
| Surface | Electro- | Electro- | Electro- | Electro- |
| Technology | Discharge | Discharge | Discharge | Discharge |
| Method | Texturing | Texturing | Texturing | Texturing |
| Surface | 2.75 μm | 1.0 μm | 1.0 μm | 1.5 μm |
| Roughness | | | | |
| | Roll 208 | | | |
| Surface Materials | Rubber | Rubber | Rubber | Steel |
| Roll 2 Diameter | 400 mm | 400 mm | 400 mm | 400 mm |
| Surface | Grinding + | Grinding + | Grinding + | Electro- |
| Technology | Polishing | Polishing | Polishing | Discharge |
| Method | | | | Texturing |
| Surface | 0.5 μm | 0.5 μm | 0.8 μm | 1.0 μm |
| Roughness | | | | |

TABLE 2
Process Conditions

| Properties | Sample 1 | Sample 2 | Sample 3 | Sample 4 |
|---|---|---|---|---|
| Die Temperature (° C.) | 262.8 | 273.7 | 270.0 | 285.0 |
| Roll 208 Water | 29.4 | 30.0 | 28.0 | 136.0 |
| Temperature (° C.) | | | | |
| Roll 210 Water | 137.8 | 132.2 | 120.0 | 146.0 |
| Temperature (° C.) | | | | |
| Nip Gap between Roll | 0.90 | 1.40 | 0.31 | 0.22 |
| 208 & 210 (mm) | | | | |
| Line Speed (m/min) | 4.1 | 9.3 | 18.0 | 16 |

Samples 1, 2, and 4 used the same polycarbonate (PC) resin. Sample 3 used a polycarbonate-polysiloxane copolymer resin (an EXRL0180 resin from GE Plastics, Pittsfield, Mass.).

The visual quality was tested under a 17 inch monitor backlight unit (BLU) manufactured by Global Display Technology (GDT). The film stack had the following configuration.

TABLE 3
Visual Quality

| Film | Manufacturer | Model No. |
|---|---|---|
| Bottom Diffuser | Tsujiden | D121 |
| Brightness | 3M | Vikuiti ™ collimating |
| Enhancement Film | | film III T |
| (collimating film) | | |
| Top Diffuser | Testing Sample | |

### The LCD panel was manufactured by Chi Mei Optoelectronics (CMO) (an anti-glare (AR) panel). The specification of the BLU is listed in Table 4. The brightness and color were measured by spectrometer, e.g., a Microvision SS320 system.

TABLE 4
Backlight Unit Specifications

| | | Specification | | |
|---|---|---|---|---|
| Item (units) | | Minimum | Typical | Maximum |
| Center Brightness (nit) | | 6,000 | 6,300 | — |
| 5 Points Average Brightness (nit) | | 4,800 | 5,300 | — |
| 9 Points Uniformity (%) | | 75 | 80 | — |
| Center Chromacity | x | 0.273 | 0.293 | 0.313 |
| determined by CIE 1931 | y | 0.280 | 0.300 | 0.320 |

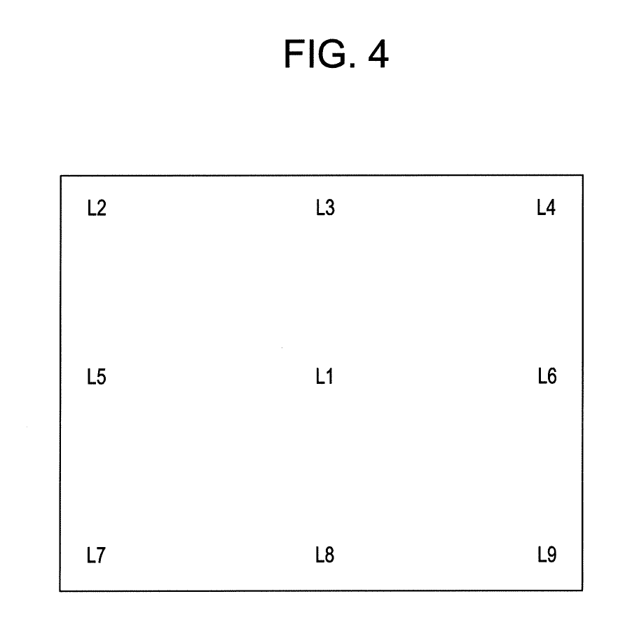

The 5 Points Average Brightness (nit) is determined by:

$$5 Points Average Brightness = \frac{L 2 + L 4 + L 7 + L 9 + L 1}{5}$$

wherein center and corners refer to locations on the display as is illustrated in FIG. 4. Meanwhile, the 9 Points Uniformity is determined by:

$$9 Points Uniformity = \frac{Minimun Luminance 9 points ( L 1 - L 9 )}{Maximum Luminance 9 points ( L 1 - L 9 )}$$

The testing was performed after the light was on for at least 30 minutes. The test environment was 25° C. (±3° C.) at a humidity of 65% (±20%).

The visual quality checking was performed when the sample was put according the above film stack with the cold cathode fluorescent lamp (CCFL) on. The average surface roughness (Ra) is tested under ASME B46.1-1995 standard with a stylus diameter of 2 micrometers (μm), stylus speed of 0.5 millimeters per second (mm/sec), and a measurement distance of 10 mm (i.e., back and forth 5 mm). The samples had a thickness of 203 μm. All samples did not have a coating (coating-free).

TABLE 5
Visual and Film Properties

| | | | | Ra (μm) | Ra (μm) |
|---|---|---|---|---|---|
| | Mura in | Mura Under panel | | Rubber side | Steel Side |
| Sample | BLU* | observation | Haze | (Roll 208) | (Roll 210) |
| 1 | Serious | Visible | 43 | 0.21 | 1.38 |
| 2 | Minor | Non-visible | 43 | 0.29 | 0.44 |
| 3 | Serious | Visible | 43 | 0.65 | 1.15 |
| 4 | Minor | Non-visible | 43 | 0.3 | 0.67 |

*backlight unit

As can be seen from the data set forth in Table 5, a film comprising a Ra on one side of 0.21 μm, and on a second side of greater than 1.3 μm (namely 1.38 μm; i.e., Sample 1), had visible (i.e., to the naked eye) mura defects under panel observation; even a Ra on one side of 0.65 μm, and on a second side of 1.15 μm (i.e., Sample 3) had visible mura defects under panel observation. However, a single, coating-free film (e.g., a monolithic film), having a Ra on both surfaces of less than or equal to about 1 μm (e.g., 0.29 μm and 0.44 μm (Sample 2) and 0.3 μm and 0.67 μm (Sample 4)), had no visible mura defects under panel observation at a center brightness of about 6,000 nit to about 6,300 nit. Also, considering that mura was observed with both the PC (Sample 1) and the polycarbonate-polysiloxane copolymer (Sample 3) samples, and since no visible mura was observed with the same PC that had visible mura under different surface roughness conditions, the present application is not limited to the polymer composition.

It has been discovered that a single layer film can be produced without visible mura defects (e.g., to the naked eye). This film does not need a coating to hide the defects. The layer has a Ra on both surfaces, individually, (e.g., a random average surface roughness) of less than or equal to 1 μm, or, more specifically, less than or equal to 0.7 μm, or, even more specifically, about 0.2 μm to about 0.6 μm, and no visible mura defects when measure under panel observation at a luminance of about 4,000 nit to about 6,000 nit, or, more specifically, a luminance of about 6,000 nit to about 6,300 nit. Production of such a film can reduce manufacturing costs (e.g., the costs associated with the use of a coating), is a more environment friendly process, and can enhance customer satisfaction due to the improved visual quality.

While the invention has been described with reference to several embodiments thereof, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A diffuser film, comprising:
a polymer composition;
a first surface; and
a second surface opposite the first surface;
wherein the diffuser film is capable of diffusing light; and
wherein the diffuser film, without a coating, has a film haze of about 10% to about 80%, and has no visible mura defects under panel observation as determined with a backlight display having a center brightness of about 6,000 nit to about 6,300 nit.

2. The film of claim 1, wherein the first surface has a first surface Ra of less than or equal to about 1 μm, and the second surface has a second surface Ra of less than or equal to about 1 μm.

3. The film of claim 2, wherein the first surface Ra and the second surface Ra are each, individually, less than or equal to about 0.7 μm.

4. The film of claim 3, wherein the first surface Ra and the second surface Ra are each, individually, about 0.2 μm to about 0.6 μm.

5. The film of claim 2, wherein the first surface Ra and the second surface Ra are each, individually, about 0.2 μm to about 0.7 μm.

6. The film of claim 2, wherein the film haze is about 40% to about 80%, and no visible mura defects.

7. The film of claim 6, wherein the first surface Ra and the second surface Ra are each, individually, about 0.2 μm to about 0.7 μm.

8. The film of claim 1, wherein the polymer composition comprises polycarbonate.

9. The film of claim 1, wherein the film haze is about 40% to about 80%, and no visible mura defects.

10. A diffuser film, comprising:
a polymer composition;
a first surface; and
a second surface opposite the first surface;
wherein the diffuser film is capable of diffusing light; and
wherein the diffuser film, without a coating, has fewer visible mura defects under panel observation as determined with a backlight display having a center brightness of about 6,000 nit to about 6,300 nit, than a second diffuser film comprising the polymer composition, and having the same thickness and haze, and having a surface with an average second diffuser surface Ra of greater than 1.3 μm.

11. The film of claim 10, wherein the first surface has a first surface Ra of less than or equal to about 1 μm, and the second surface has a second surface Ra of less than or equal to about 1 μm.

12. The film of claim 11, wherein the first surface Ra and the second surface Ra are each, individually, less than or equal to about 0.7 μm.

13. The film of claim 10, wherein the polymer composition comprises polycarbonate.

14. The film of claim 10, wherein the film has a film haze of about 40% to about 80%, and no visible mura defects.

15. The film of claim 14, wherein the first surface has a first surface Ra of about 0.2 μm to about 0.7 μm, and the second surface has a second surface Ra of about 0.2 μm to about 0.7 μm.

16. A method for making a diffuser film, comprising:
heating a polymer to greater than or equal to a glass transition temperature of the polymer to form a polymer melt; and
producing the diffuser film with a surface texture on each side of the diffuser film;
wherein the diffuser film is capable of diffusing light; and
wherein the diffuser film, without a coating, has no visible mura defects under panel observation as determined with a backlight display having a center brightness of about 4,000 nit to about 6,300 nit.

17. The method of claim 16, wherein producing the diffuser film further comprises
extruding the polymer melt; and
introducing the polymer melt to a nip between a first calendaring roll and a second calendaring roll.

18. The method of claim 16, wherein the first calendaring roll and the second calendaring roll, individually, have a Ra of less than or equal to about 1 μm.

19. The method of claim 16, wherein the surface texture on each side of the film is, individually, less than or equal to about 0.7 μm.

20. The method of claim 16, wherein the diffuser film has a film haze of about 40% to about 80%.

21. The method of claim 16, wherein the center brightness is about 6,000 to about 6,300.
